(19) United States
(12) Patent Application Publication
(10) Pub. No.: US 2010/0018296 A1
(43) Pub. Date: Jan. 28, 2010

(54) PENETROMETER WITH LIGHT-WEIGHT, ELECTRONICALLY-CONTROLLED HAMMERING MODULE

(76) Inventors: Kris A. ZACNY, New York, NY (US); David Glaser, Berkeley, CA (US)

Correspondence Address: Leighton K. Chong;IP & Patent Attorney, 133 Kaal Street, Honolulu, HI, 96821, US

(21) Appl. No.: 12/555,776

(22) Filed: Sep. 8, 2009

Related U.S. Application Data
(63) Continuation-in-part of application No. 11/756,604, filed on May 31, 2007.
(60) Provisional application No. 60/804,076, filed on Jun. 6, 2006.

(51) Int. Cl. G01N 3/40

(52) U.S. Cl. 73/84

(57) ABSTRACT

A light-weight electronically-controlled hammering module is used to apply a repetitive hammering force under electronic control to the top end of a dynamic cone penetrometer rod. In a preferred embodiment, the hammering module has a battery-powered percussive hammer that applies an electrically-generated impulse hammering force to the top of the rod. The depth of penetration is measured with a range-finder and used to compute the rate of penetration of the rod into the ground and correlated to the strength of the soil. The rate of hammering is controlled to cause the rod to penetrate into the soil at a controlled rate correlated with the strength of the soil.

This is a continuation-in-part application from U.S. patent application Ser. No. 11/756,604 filed on May 31, 2007, by the same inventors, which claimed the priority of U.S. Provisional Application No. 60/804,076 filed on Jun. 6, 2006, entitled “Percussive Cone Penetrometer and Accelerated Cone Penetrometer”.

The subject matter herein was developed for ERDC as part of the “Rapid In-Situ Soil Characterisation System”, funded through the Department of Defense SBIR Phase I program. The U.S. Government retains certain rights in the invention.

### TECHNICAL FIELD

This invention relates to an improved penetrometer device for applying a hammering impulse force to drive a rod into the ground to a desired level.

### BACKGROUND OF INVENTION

A penetrometer is used for performing soil strength measurements in the field. The measurements obtained can be correlated with the engineering soil strength parameter such as the California Bearing Ratio (CBR), a widely accepted standard in civil engineering, or possibly with a physical soil strength parameter, such as a soil bearing strength. Soil strength measurements are used in the construction of paved and unpaved roads, airfields, and building foundations.

As an example of a prior device, a dynamic cone penetrometer (DCP) is described in U.S. Pat. No. 5,313,825, issued May 24, 1994, for performing soil strength measurement making use of a sliding hammer (one of two different weights) that is manually lifted and dropped onto a steel rod having a cone-shaped point. Each time the hammer is dropped, the rod penetrates deeper into the soil. The depth of penetration is measured with an integrated ruler and this data is later converted to an index that is then correlated to the CBR. The Dual-Mass DCP measurement meets the industry standards of ASTM D6951.

Prior devices also include an automated dynamic cone penetrometer (ADCP) which employs the same cone rod and hammer as the DCP device, but, in place of a human operator, a mechanism is used to automatically lift the DCP hammer. The hammer is then gravity dropped. The entire device is heavy and must be mounted on a trailer or other wheeled vehicle.

The disadvantages of the prior art are many. For the DCP device, repeated manual lifting of the sliding hammer causes fatigue on the part of the human operator (which in turn reduces the accuracy of the measurement because tired operator doe not lift the hammer all the way to the top) and/or requires multiple operators to avoid fatigue. Operators frequently injure themselves by getting pinched by the sliding hammer. Operators also require hearing protection because individual hammer blows are very noisy. The quality of the measurements is compromised by operator error in manually taking the depth measurements, particularly in cases where fatigue has set in. The measured data needs to be manually typed into the spreadsheet to obtain the CBR. This extra information makes the process more time consuming. The lighter of the two standard hammers is intended for use with weaker soils. However, operators without proper training may not be able to identify when the smaller hammer should be used. Furthermore, changing from one hammer to another is cumbersome and time consuming. Also, for extremely weak soils, the lighter hammer is still too heavy to produce the best possible results. The pressure wave developed in the device may also break the braze between the rod and the hammer assembly making the device useless.

For the ADCP device, the main disadvantage is the large size and mass of the unit. It must be mounted on a trailer or a small truck and this restricts the locations where it can be used. It also has the same disadvantages as the DCP device with regard to changing hammers and providing accurate measurements in very weak soils.

### SUMMARY OF INVENTION

In the present invention, a light-weight, electronically-controlled hammering module is used to apply a repetitive hammering force under electronic control to the top end of a penetrometer rod. The hammering frequency is controlled by electronic controls to generate comparable impacts as heavy, gravity-dropped prior art devices by electronically moving a much smaller mass at a much higher frequency of impacts. In a preferred embodiment, the hammering module has a battery-powered percussive hammer that sits on top of the rod which, when activated, applies an electrically-generated impulse hammering force to the top of the rod. The hammering force is generated by electrically driving a small mass, e.g., 1 kg or less and even as low as 100 gm, at a controlled rate, e.g., of 5-50 Hz. The faster the rate of hammering, the more impact applied, so higher rates are used for stronger soils and lower rates for weaker soils. This application of force causes the cone-shaped point of the rod to penetrate into the soil at a controlled rate that is correlated with the strength of the soil. Therefore in this constant penetration mode, the impact energy is correlated to the soil strength. In the constant energy mode, however, the hammering frequency is kept constant, while the resultant penetration rate is correlated with the strength of soil.

Other objects, features, and advantages of the present invention will be explained in the following detailed description of the invention having reference to the appended drawings.

### DESCRIPTION OF DRAWING FIGURES

FIG. 1 illustrates an overall view of a light-weight, electronically controlled hammering module for a penetrometer rod.

FIG. 2 shows a first embodiment of the hammering module of an air spring design.

FIG. 3 shows a second embodiment of the hammering module of a cam & spring design.

FIG. 4 shows a third embodiment of the hammering module of a voicecoil design.

FIG. 5A illustrates operation of the hammering module in energy controlled mode, and

FIG. 5B illustrates operation of the hammering module in penetration controlled mode.

FIG. 6 illustrates calibration of the light-weight, electronically controlled hammering module to conduct soil strength measurements.

### DETAILED DESCRIPTION OF INVENTION

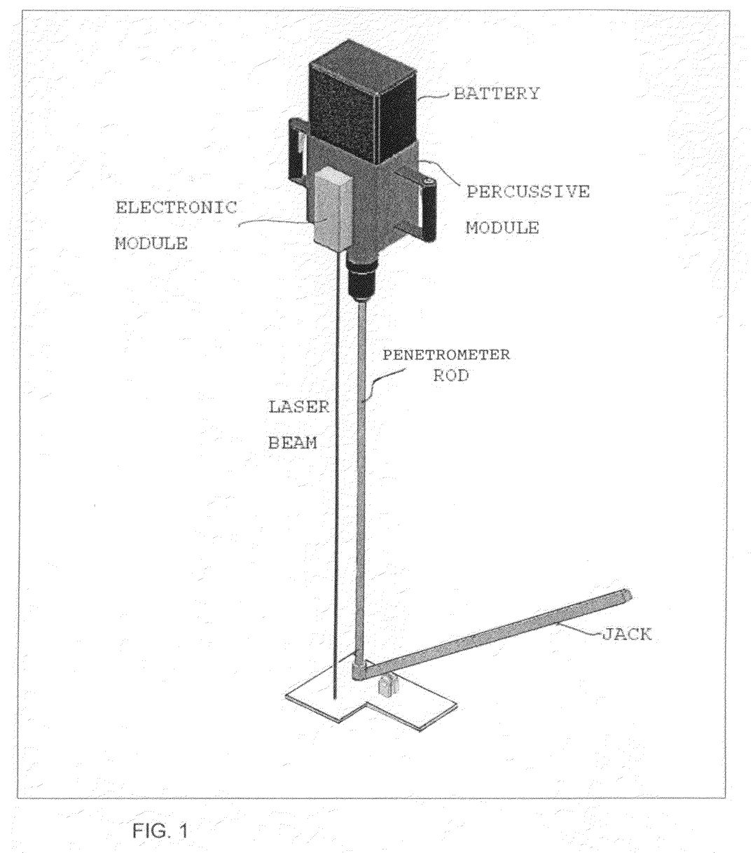

FIG. 1 shows a schematic perspective view of a penetrometer with a light-weight, electronically-controlled hammering module in accordance with the present invention. The hammering module applies a controlled hammering force to the top of a driven end of a long, rigid rod having an opposite ground piercing end, referenced in the figure as a dynamic cone penetrometer (DCP) rod, to drive its ground-piercing end into the ground. In a preferred embodiment adapted for field use, the hammering module includes an electronic (control) module, a battery as a power source, and a percussive module for applying a controlled and repetitive percussive hammering force to the top of the rod. A jack is used to facilitate removal of the rod from the ground.

The application of the hammering force causes the cone-shaped point of the DCP rod to penetrate into the soil at a controlled rate that is correlated with the strength of the soil. The depth of penetration is determined by noting the decrease in distance between the initial height of the rod and its lower position as it descends into the ground. This distance is measured, for example, by a time-of-flight laser rangefinder (emitting a laser beam) that is mounted with the electronic module on the side of the percussive module and pointed at a suitable reflective surface placed on the ground adjacent to the location of penetration. Measurements from the laser rangefinder are transmitted by wire, or wirelessly, to a portable computer, where a software algorithm can compute the rate of penetration and in turn the soil strength profile. Control software will adjust the hammering rate to a level appropriate for the strength of the soil.

In the percussive module, the hammering force is generated by electrically driving a small mass at a controlled rate. For example, the mass can be of approximately 100 gm weight, and the rate of impulse driving can be of 5-50 Hz. The faster the rate of hammering, the more impact applied, so higher rates are used for stronger soils and lower rates for weaker soils. Thus, the rod can be driven into the soil with high frequency blows (in the range of 50 Hz) with low impulse energy (0.5-10 J).

The control software is adapted to read the depth data in real time and adjust the impulse of the hammering to keep the rate of penetration within a desired range, or to keep the rate of penetration constant. The software can consequently calculate, in real time, the penetration rate in blows per minute and compute the strength of the formation in California Bearing Ratio or some engineering property, such as soil bearing strength.

The automatically acquired depth measurements greatly reduce the amount of operator error and also speed up the determination of the soil's strength profile. The real-time penetration data are also used to instantly adjust the hammering energy to a level appropriate for the soil being tested, unlike the prior art, which requires a judgment determination and then several minutes to change from one hammer to another. Furthermore, the hammering energy can be made very small, to provide a more accurate correlation to CBR in weak soils than the prior types of DCP or ADCP hammers. The use of very small hammer impulses, which are controlled so as to maintain a constant rate of penetration, also confers on the invention the ability to measure actual engineering properties of the soil.

This invention has advantages over the prior types of penetrometers in that it is much easier to operate, requiring the user only to orient the unit upright such that the rod remains vertical, turn the unit on, and then maintain a light pressure to keep the unit vertical until the rod penetrates 2 inches into the soil. Thereafter the rod is guided vertically by the sides of the hole and no operator assistance is required. Its operation does not require the user to have superior physical strength and does not result in user fatigue. Additionally, the risk of injury to the user is much lower because the hammering mechanism is not exposed. The improved penetrometer only employs three easily assembled components. It is lightweight and portable enough to be carried by a single person, even to remote locations. It can be operated by a single person, while the prior art devices can require two or more. Use of the improved penetrometer, including set up, operation, and break down, takes significantly less time than the prior art devices. Being an automated device, the action of hammering the rod into the ground is subject to automated control, resulting in more consistent soil strength data and also less time for each individual test.

Other modifications and variations may be made in accordance with the circumstances of field use for which the penetrometer is to be employed. The control software may be encoded in a simplified form for rugged use, e.g., as a stored look-up table in read-only memory ROM, that is embedded with the electronic (control) module rather than operated on a separate computer. This would be advantageous for highly mobile use by a single operator over far-ranging distances.

The hammer mechanism can be powered pneumatically or by internal combustion, rather than battery-powered. A heavier hammer, in the range of 500-1000 gm, can be made to impact with higher energy, but at a slower rate, e.g., 1-5 Hz. This embodiment is referred to as an Accelerated Cone Penetrometer (ACP). The rod that is driven into the soil may be made of other materials, for example, titanium alloy or aluminum alloy, and other penetration point configurations may be used, such as 30° instead of DCP 60°.

The method of measuring the depth of penetration can be with any other non-contact method, such as an ultrasonic rangefinder, or it can be mechanical, making use of a wheel traveling along a guided track, or a string that is anchored to the ground and is retracted as penetration proceeds.

Instead of keeping impact energy or impulse the same and controlling the rate of penetration, an alternative approach is to keep the penetration rate constant by changing the impulse or impact energy. In this method, the impact energy or impulse could be correlated to either an engineering soil property or a physical soil property.

Instead of keeping the rate of penetration the same (or within the certain range) by controlling the impact energy or impulse, an alternative approach is to keep the impact energy or impulse the same and record the rate of penetration (as is done with the DCP and ADCP). In this method, the penetration rate could be correlated to either an engineering soil property or a physical soil property.

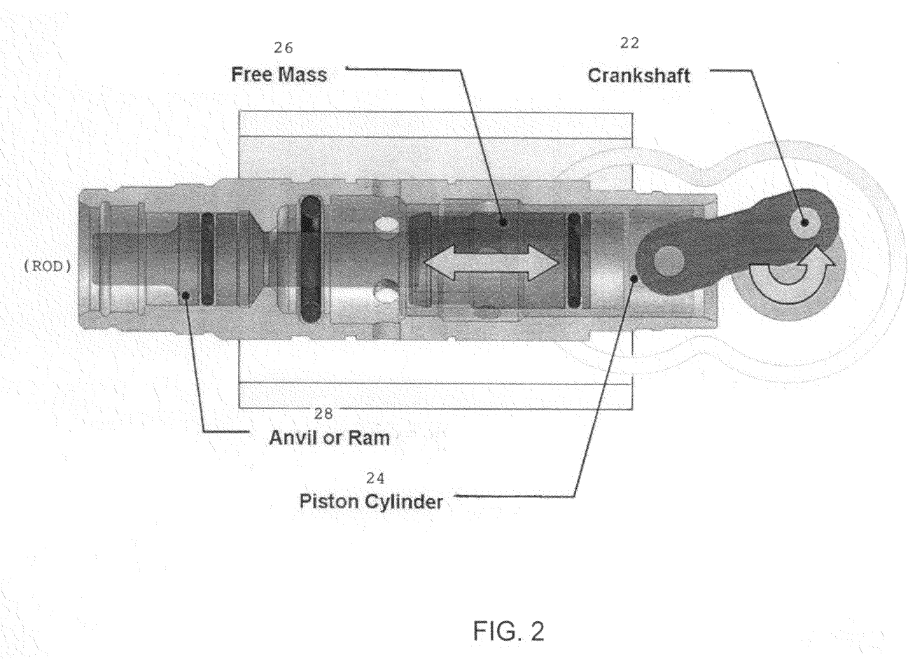

In FIG. 2, a first embodiment of a light-weight, electronically controlled hammering module for the penetrometer device is of an “air spring” design, in which a rotary motor (not shown) is used to turn a crankshaft 22 to drive in reciprocation a piston cylinder 24 holding a “free mass” 26 which rides inside of and moves with the reciprocating cylinder. At a withdrawal segment of the reciprocation cycle moving to the right side of the figure, the cylinder 24 draws the free mass 26 to the rightmost position by creating suction. At a release segment of the reciprocation cycle, the free mass is pushed toward the left side of the figure via compressed air and once air escapes released for impact by momentum against an anvil 28 coupled or in mechanical abutment with the proximal end of the penetrometer rod.

With each rotational cycle of the crankshaft 22, the free mass is pulled back to start the cycle and released to impact the anvil 28 and penetrometer rod. The frequency can be increased by increasing the motor rotational velocity. The impact energy is a function of the free mass and its velocity. In this manner, a small free mass, such as of 1 kg or lower (even as small as 0.1 kg), can deliver as much or more impact energy to the rod as the prior art DCP device by multiplying the frequency of impacts in a given amount of time. The free mass movement is essentially dictated by the air flow in the reciprocating system. When the reciprocating system is closed, the loss or addition of air to the system is essentially negligible and the system can be considered closed. In its closed state the free mass motion is couple to that of the cylinder. When the system is opened to outside air, the free mass is decoupled from the cylinder's motion and then travels until it strikes the anvil.

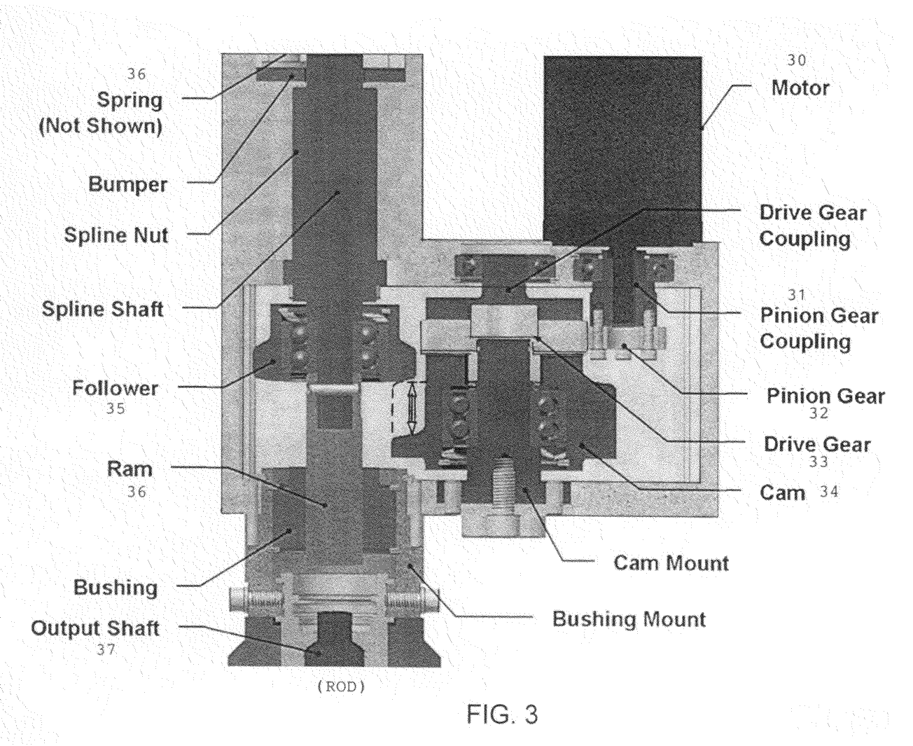

In FIG. 3, a second embodiment of the hammering module is of a “cam & spring” design. A motor 30 drives a pinion gear coupling 31 to a pinion gear 32 which drives a drive gear 33 which rotates an eccentric cam 34. A cam follower 35 travels in contact with the cam 34 in reciprocation (doubled-headed arrow) as the cam rotates. When traveling in the upward direction in the figure, the follower 35 is lifted and pushed against a compression spring 36 as the cam rotates. When the eccentric part of the cam is reached, the follower is released to travel in the downward direction in the figure under the force of the spring and accelerated until the coupled ram 36 strikes the output shaft anvil 37 which transmits the impact force to the penetrometer rod. With each cycle, the cam 34 picks up the follower 35 again and releases it to impact the anvil. The mechanism frequency can be changed by changing the rotation speed of the motor. The impact energy can be adjusted by selecting the desired spring force.

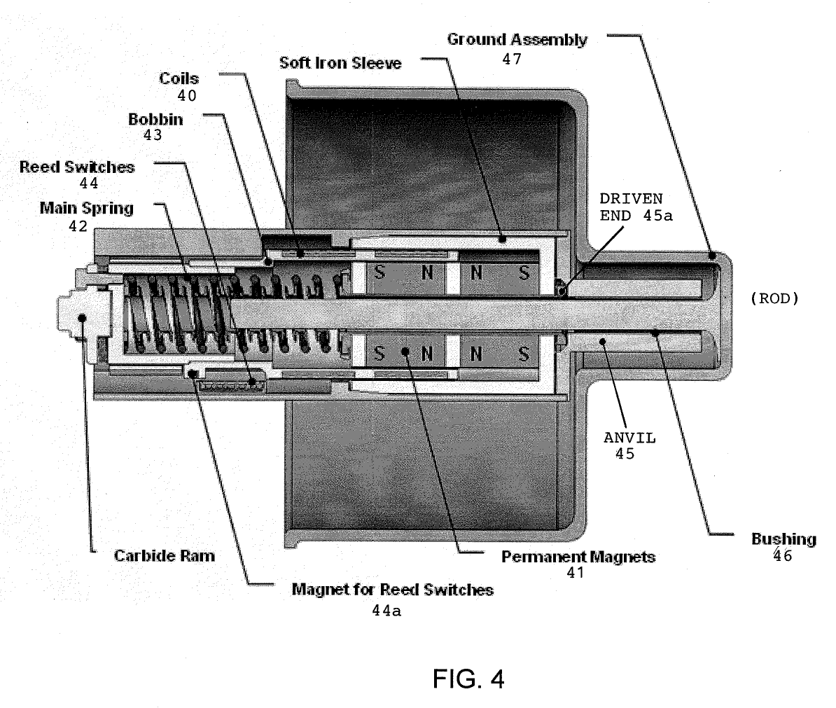

In FIG. 4, a third embodiment of the hammering module is of a “voicecoil” design. A voltage is applied to send a current through a conductor coil 40 that produces a magnetic force to pull permanent magnets 41 in an axial direction to the left side of the figure against the force of the compression main spring 42. When a bobbin 43 that moves with the magnets 41 actuates a magnet for reed switches 44, the current is cut off and the permanent magnets 41 are released, and the compression force of the main spring 42 is applied to propel a driven end 45a sliding on a bushing 46 against an anvil 45 within a ground assembly 47 which transmits the impact to the penetrometer rod. The higher the voltage applied to the coils is, the higher the force on the magnets and therefore the speed of reciprocation. In this case, the voicecoil is used to preload the spring, then it is suddenly de-energized, or energized in the opposite direction to produce an impact. Control of the voltage applied and current flowing in the coils is used to control the cycling frequency of the device and the impact energy delivered.

The Dynamic Cone Penetrometer (DCP) device of the prior art uses a heavy mass such as 8 kg that must be mechanically lifted and gravity-dropped to generate impacts/percussion. Because the hammer is gravity-dropped, the impact frequency is limited by the time it takes the hammer be lifted and dropped, typically a distance of 30 inches. The prior art SAPPER device, which automates lifting of the 8 kg DCP hammer can achieve a maximum practical impact frequency of the order of only 0.5-2 Hz (depending on how fast the hammer can be lifted).

In contrast, the present invention employs a light-weight, electronically controlled hammering module in which the hammering frequency is controlled by electronic controls to generate comparable impacts by moving a much smaller mass at a much higher frequency. This offers reductions in both the overall weight and size of the device. In the above-described embodiments of the electronically controlled hammering module, the impact frequency and total impact energy delivered can be readily controlled by varying motor or coil voltage and current only. Thus, an embodiment of the system shown in FIG. 3 can weigh about 10 lbs and have a length 14 inches long. With a battery pack, control electronics and a depth sensor, the entire system can weigh about 20 lbs, making it easily portable. By comparison, the SAPPER system weighs 100 lbs (without batteries), and recommended use of a hitch/lift assembly weighs an additional 45 lbs.

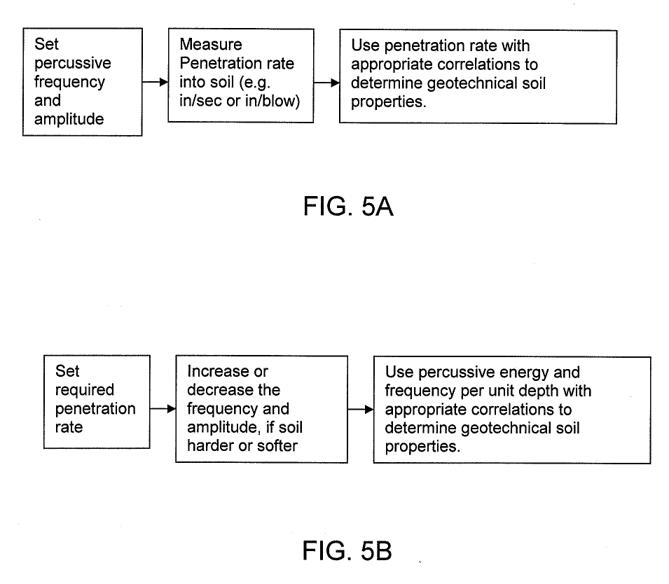

The light-weight, electronically controlled hammering module can be used to test soil strength in real time and with high precision. As compared to the SAPPER/DCP device which uses a constant energy per blow to drive the rod into soil a depth that is measured to infer geotechnical soil properties, the electronically controlled hammering module can be operated in two modes: energy controlled and rate controlled. In the energy controlled mode illustrated in FIG. 5A, a constant hammer frequency and hammer blow energy is used. The penetration rate of the rod into the soil is used to infer soil geotechnical properties. In the rate controlled mode illustrated in FIG. 5B, the penetration rate of the rod into the soil is kept constant by adjusting the percussive frequency and/or percussive energy.

In the energy controlled mode, the light-weight, electronically controlled hammering module can maintain a constant energy per blow and fix the frequency (like the Dynamic Cone Penetrometer (DCP)) to measure the soil penetration rate (inch/blow or inch/sec). After appropriate correlations, the penetration rate can then be reported in terms of a standard California Bearing Ratio (CBR). In the rate controlled mode, the light-weight, electronically controlled hammering module can maintain a constant soil penetration rate (like the Static Cone Penetrometer (SCP)) and measure the energy/force required. The energy/force measured can then be correlated to other geotechnical soil properties, such as bearing strength.

If the hammering module is vehicle deployable, the deployment system can use a load cell for maintaining a certain preload on it. The percussive energy, frequency and penetration rate could then be kept constant, while the preload can be increased or decreased. The force required to push the cone, while maintaining constant percussive energy and frequency could then be converted to bearing strength, akin to measuring bearing strength from a Static Cone Penetrometer. This approach is not possible with DCP device.

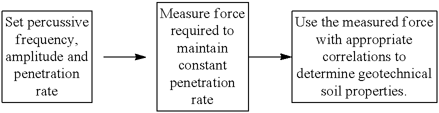

The above chart illustrates a penetration controlled mode when robotically deployed using a Z-axis drive and a load cell. The Z-axis drive maintains a constant penetration rate, while the load cell measures the penetration force required to maintain the constant penetration rate.

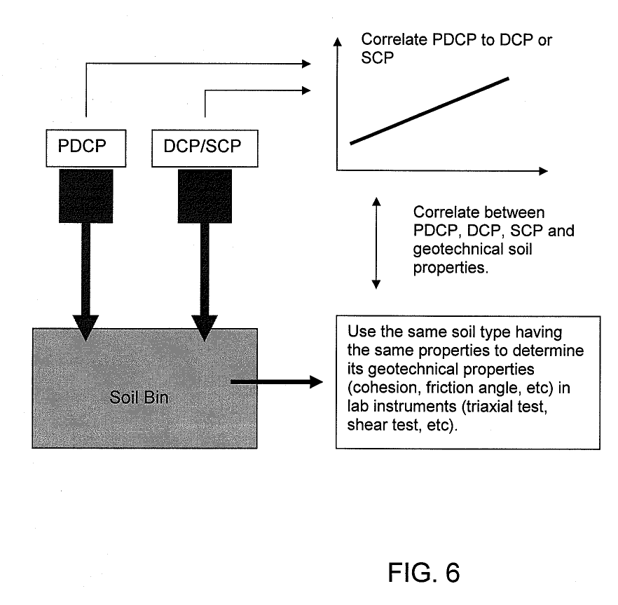

FIG. 6 illustrates calibration of the light-weight, electronically controlled hammering module to conduct soil strength measurements. Calibration involves side by side testing of the hammering module with other soil instruments such as the DCP device to determine soil geotechnical properties such as soil bearing strength or California Bearing Ratio, and the Static Cone Penetrometer (SCP). The tests are conducted in soil bins having a variety of soils of known densities and moisture content. The laboratory soil data from shear or triaxial tests on these soils will give accurate measure of soil cohesion and friction angle and by extent its shear strength and bearing ratio.

While certain embodiments and improvements have been described above, it is understood that many other modifications and variations thereto may be devised given the above description of the principles of the invention. It is intended that all such modifications and variations be considered as within the spirit and scope of this invention, as defined in the following claims.

1. A penetrometer device comprising:
a long rigid rod having a driven end and an opposite, ground-piercing end for piercing into the ground; and
a light-weight, electronically-controlled hammering module having an electronically controlled hammering mechanism for generating a repetitive hammering force by a relatively small mass of 1 kg or less at a relatively high frequency of impulse driving under electronic control to deliver an impact energy to the driven end of the rod that is comparable to gravity-dropped devices having a relatively heavy mass dropped at a relatively low frequency of repetition.

2. A penetrometer device according to claim 1, wherein the rod is a penetrometer rod having a cone-shaped point for penetrating into the ground.

3. A penetrometer device according to claim 1, wherein the hammering module includes an electronic (control) module and a battery as a power source.

4. A penetrometer device according to claim 1, wherein the hammering module includes range-finding means for measuring the height of the top end of the rod from the ground as a measure of depth of penetration.

5. A penetrometer device according to claim 4, wherein the measure of depth of penetration into the ground is used to compute a rate of penetration that is correlated to the strength of the soil in the ground.

6. A penetrometer device according to claim 4, wherein the electronic module transmits signals from the range-finding means representing the depth of penetration into the ground by wire or wirelessly to a portable computer in order to compute the rate of penetration.

7. A penetrometer device according to claim 4, wherein the electronic module is embedded with computing means for receiving signals from the range-finding means representing the depth of penetration into the ground in order to compute the rate of penetration.

8. A penetrometer device according to claim 5 wherein the rate of penetration representing the soil strength profile is used to adjust the hammering rate of the hammering module to a level appropriate for the strength of the soil.

9. A penetrometer device according to claim 1, wherein the hammering module is of a air spring design having a motor-driven crankshaft to drive in reciprocation a piston cylinder holding a free mass which rides inside of and moves with the reciprocating cylinder.

10. A penetrometer device according to claim 1, wherein the hammering module is of a cam & spring design having a motor-driven pinion gear which drives a drive gear that rotates an eccentric cam to lift a cam follower against a compression spring and release it in reciprocation as the cam rotates.

11. A penetrometer device according to claim 1, wherein the hammering module is of a voicecoil design having a current-carrying conductor coil that produces a magnetic force to pull a magnet-coupled driven piece against the force of a compression spring and release it in reciprocation when the current is cut off.

12. A penetrometer device according to claim 1, wherein the small mass is approximately a 100 gm weight, and the rate of impulse driving is in the range of 5-50 Hz.

13. A penetrometer device according to claim 1, wherein the small mass is in the range of 500-1000 gm and the rate of impulse driving is 1-5 Hz.

14. A method of operating a penetrometer device having a long rigid rod with a driven end and an opposite, ground-piercing end for piercing into the ground, comprising:
providing a hammering module for generating a repetitive hammering force using a relatively small mass of 1 kg or less;
electronically controlling the hammering module at a relatively high frequency of impulse driving to deliver an impact energy to the driven end of the rod that is comparable to gravity-dropped devices having a relatively heavy mass dropped at a relatively low frequency of repetition.

15. A method of operating a penetrometer device according to claim 14, further including measuring the height of the top end of the rod from the ground as a measure of depth of penetration of the rod into the ground, and using the measure of depth of penetration into the ground to compute a rate of penetration that is correlated to the strength of the soil in the ground.

16. A method of operating a penetrometer device according to claim 15, wherein the rate of penetration representing the soil strength profile is used to adjust the hammering rate to a level appropriate for the strength of the soil.

17. A method of operating a penetrometer device according to claim 14, wherein the hammering force is generated by electrically driving a hammer of small mass of approximately 100 gm weight, and the rate of impulse driving is in the range of 5-50 Hz.

18. A method of operating a penetrometer device according to claim 14, wherein the hammering force is generated by electrically driving a hammer of larger mass of approximately 500 to 1000 gm weight, and the rate of impulse driving is in the range of 1-5 Hz.

19. A method of operating a penetrometer device according to claim 14, wherein the electronically controlling step is operated to test soil characteristics in an energy-controlled mode and in a rate controlled mode, and wherein the electronically controlling step is calibrated against standard rates of penetration of a dynamic cone penetrometer (DCP) type of device in the energy-controlled mode and standard depths of penetration of a static cone penetrometer (SCP) type of device in a rate controlled mode.

20. A method of operating a penetrometer device according to claim 14, wherein the penetrometer device is robotically deployed using a Z-axis drive and a load cell, the Z-axis drive maintains constant penetration rate, and the load cell measures the penetration force required to maintain a constant penetration rate.
